(19) United States
(12) Patent Application Publication
(10) Pub. No.: US 2025/0391271 A1
(43) Pub. Date: Dec. 25, 2025

(54) AGENT CONTROL SYSTEM AND AGENT CONTROL METHOD

(71) Applicant: HITACHI, LTD., Tokyo (JP)

(72) Inventors: Tadashi KOTANI, Tokyo (JP); Shinji ISHIHARA, Tokyo (JP); Ryu NARIKAWA, Tokyo (JP); Masaki KANAI, Tokyo (JP); Kazuya SUGIMOTO, Tokyo (JP)

(21) Appl. No.: 18/992,972

(22) PCT Filed: May 12, 2023
(86) PCT No.: PCT/JP2023/017993

§ 371 Date: Jan. 9, 2025

(30) Foreign Application Priority Data
Jul. 22, 2022 (JP) 2022-117021

(51) Int. Cl. G08G 1/123; G01C 21/34

(52) U.S. Cl. CPC G08G 1/123; G01C 21/3492

(57) ABSTRACT

Provided is an agent control system of the like in which an agent can perform predetermined tasks during monitoring. The agent control system comprises: a monitoring status evaluation unit that calculates a monitoring evaluation index indicating the quality of the monitoring status for each location within a predetermined area on the basis of monitoring information sent from an agent moving within the predetermined area; a global route generation unit that generates a route plan for the agent on the basis of business management information including the agent's destination and task type, and the monitoring evaluation index; and a route plan transmission unit that transmits route plan data to the agent.

### TECHNICAL FIELD

The present invention relates to an agent control system and the like.

### BACKGROUND ART

Automated transport systems that allow agents (transport vehicles such as automobiles) to transport cargo or people from a certain location to a destination in a predetermined area are used in various fields. In the automated transport systems, it is desirable to make a route plan to reduce a risk of collision of an agent with a non-controlled object (e.g., a manually driven vehicle or a person) in an area, such as a town, in which a controlled-object (e.g., a self-driving vehicle) and the non-controlled object are present.

Regarding such a technique, for example, Patent Literature 1 describes that “a moving object sorting unit determines a risk potential to be monitored such that each of a search degree and a degree of following satisfy predetermined levels, and assigns multiple moving objects to a risk potential determined as the risk potential to be monitored”.

### CITATION LIST

### Patent Literature

Patent Literature 1: Japanese Unexamined Patent Application Publication No. 2019-16306

### SUMMARY OF INVENTION

### Technical Problem

However, in the technique described in Patent Literature 1, only monitoring within a predetermined area is considered and a case where another task (e.g., transport of cargo or people) is performed is not particularly considered. In the technique described in Patent Literature 1, if a predetermined task other than monitoring is also performed, a dedicated agent for the task is required and there is a possibility that a large number of agents may be required.

Therefore, an object of the present invention is to provide an agent control system and the like that enable an agent to perform a predetermined task while performing monitoring.

### Solution to Problem

To solve the problems, an agent control system according to the present invention includes: a monitoring state evaluation unit that calculates, based on monitoring information transmitted from an agent that moves in a predetermined region, a monitoring evaluation index indicating whether or not a monitoring state at each location in the predetermined region is good; a route plan generation unit that generates a route plan for the agent based on work management information including a destination of the agent and a type of a task and the monitoring evaluation index; and a route plan transmission unit that transmits data of the route plan to the agent.

### Advantageous Effects of Invention

According to the present invention, it is possible to provide an agent control system and the like that enable an agent to perform a predetermined task while performing monitoring.

### BRIEF DESCRIPTION OF DRAWINGS

FIG. 1 is a functional block diagram of an agent control system according to a first embodiment.

FIG. 2 is a functional block diagram illustrating a system configuration of an agent in the agent control system according to the first embodiment.

FIG. 3 is an explanatory diagram regarding dimensions and orientation of the agent in the agent control system according to the first embodiment.

FIG. 4 is a functional block diagram illustrating a system configuration of a base station in the agent control system according to the first embodiment.

FIG. 5A is a diagram illustrating an example of map information in the agent control system according to the first embodiment.

FIG. 5B is a partial enlarged view of a region K1 in the map information illustrated in FIG. 5A and used in the agent control system according to the first embodiment.

FIG. 6A is an explanatory diagram of a coefficient αₒⱼ used for calculation of monitoring evaluation indices in the agent control system according to the first embodiment.

FIG. 6B is an explanatory diagram of a coefficient αₘⱼ used for calculation of the monitoring evaluation indices in the agent control system according to the first embodiment.

FIG. 7A is an explanatory diagram illustrating routes of agents according to a comparative example.

FIG. 7B is an explanatory diagram illustrating global routes of the agents in the agent control system according to the first embodiment.

FIG. 8 is an explanatory diagram illustrating a relationship between a monitoring evaluation index Cₘⱼ and a weight Wₘⱼ in the agent control system according to the first embodiment.

FIG. 9A is an explanatory diagram illustrating a traffic condition at a time t=k in an area in a predetermined region in the agent control system according to the first embodiment.

FIG. 9B is an explanatory diagram illustrating a traffic condition at a time t=k+1 in the area in the predetermined region in the agent control system according to the first embodiment.

FIG. 10 is an explanatory diagram illustrating a condition for avoiding contact with an obstacle in the agent control system according to the first embodiment.

FIG. 11 is a flowchart illustrating an operation procedure of an agent control unit included in the agent control system according to the first embodiment.

FIG. 12 is a functional block diagram illustrating an agent control system according to a second embodiment.

FIG. 13 is a functional block diagram illustrating a system configuration of a base station in the agent control system according to the second embodiment.

FIG. 14 is an explanatory diagram illustrating an example of an operation of a monitoring rate calculation unit in the agent control system according to the second embodiment.

FIG. 15 is an explanatory diagram illustrating a theme park to which an agent control system according to a third embodiment is applied.

FIG. 16A is an explanatory diagram illustrating routes of agents according to a comparative example.

FIG. 16B is an explanatory diagram illustrating global routes of the agents in the agent control system according to the third embodiment.

FIG. 17 is an explanatory diagram illustrating traveling routes of the agents in the agent control system according to the third embodiment.

### DESCRIPTION OF EMBODIMENTS

### First Embodiment

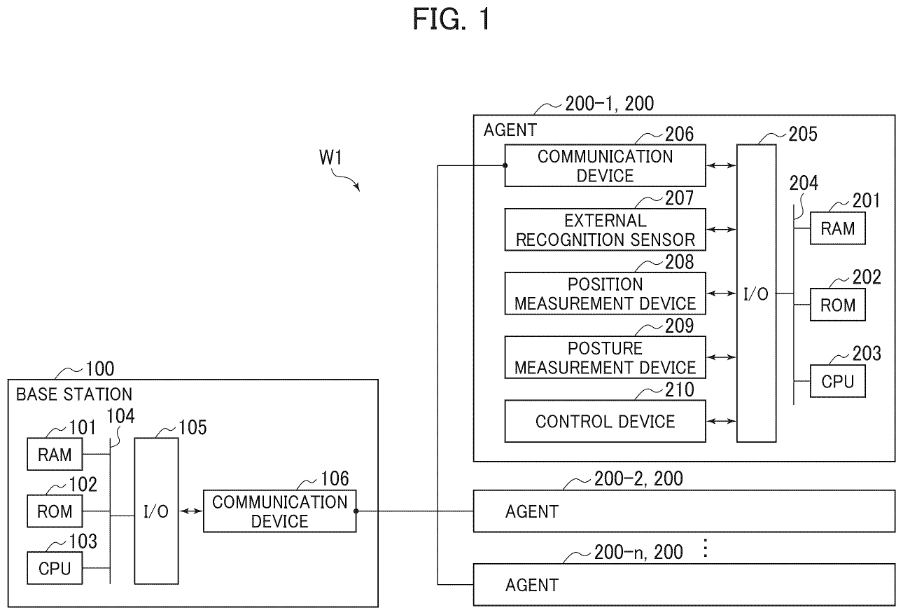

FIG. 1 is a functional block diagram of an agent control system W1 according to a first embodiment.

The agent control system W1 is a system that calculates a route plan (time-series data of coordinates, postures, velocities, and the like) for agents 200-1 to 200-n (controllable moving objects such as robots or vehicles) in a predetermined region (e.g., a specific area or a theme park) and causes the agents 200-1 to 200-n to move based on this route plan.

The first embodiment will describe, as an example, a system that in which a self-driving vehicle delivers a person or goods in the predetermined region. The application of the first embodiment is not limited to the self-driving vehicle in the predetermined region and the first embodiment can be applied to a transport vehicle and the like in an area such as a harbor or a theme park as described later. In addition, the agents 200-1 to 200-n are moving objects that are autonomously driven based on an instruction from a base station 100 (server). In a case where a predetermined agent serves as the base station 100, the base station 100 can be omitted.

As illustrated in FIG. 1, the agent control system W1 includes the base station 100 that calculates routes of the agents 200-1 to 200-n in the predetermined region, and the agents 200-1 to 200n that move along the routes calculated by the base station 100.

### <Base Station>

The base station 100 calculates traveling routes of the agents 200-1 to 200-n. The base station 100 includes a random access memory (RAM) 101 that is a volatile storage component, a read only memory (ROM) 102 that is a non-volatile storage component, and a central processing unit (CPU) 103 that includes a processor. The base station 100 further includes a bus 104, an input and output interface 105, and a communication device 106, in addition to the above-described configuration. The CPU 103 executes various types of processing by reading a program stored in the ROM 102 and developing the program into the RAM 101.

The bus 104 is a signal line that connects the RAM 101, the ROM 102, the CPU 103, and the input and output interface 105 to each other. The input and output interface 105 is used to data transmission via the communication device 106. The communication device 106 performs predetermined wireless communication with the agents 200-1 to 200-n. The communication device 106 is connected to the bus 104 via the input and output interface 105.

Although FIG. 1 illustrates an example in which the single base station 100 is provided, the number of base stations 100 is not limited thereto. For example, a plurality of base stations may serve as a single server. In addition, one or more of the agents 200-1 to 200-n may serve as the base station 100.

### <Agents 200>

The agents 200-1 to 200-n perform monitoring in the predetermined region and travel by following routes based on route information transmitted from the base station 100 via wireless communication. In the following description, it is assumed that the agents 200-1 to 200-n are vehicles and that in a case where the agents 200-1 to 200-n are collectively referred to as agents, the agents 200-1 to 200-n are referred to as agents 200. As illustrated in FIG. 1, each of the agents 200 includes a RAM 201, a ROM 202, a CPU 203, a bus 204, and an input and output interface 205. The agent 200 includes, in addition to the above-described configuration, a communication device 206, an external recognition sensor 207, a position measurement device 208, a posture measurement device 209, and a control device 210.

In the example illustrated in FIG. 1, the RAM 201, the ROM 202, and the CPU 203 are connected to the input and output interface 205 via the bus 204. In addition, the communication device 206, the external recognition sensor 207, the position measurement device 208, the posture measurement device 209, and the control device 210 are connected to the input and output interface 205. The agent 200 that has the configuration described above moves based on the route information transmitted from the base station 100 via wireless communication, monitors a traveling environment using the external recognition sensor 207, and transmits a result of the monitoring to the base station 100.

The communication device 206 is, for example, a terminal that can perform wireless communication via Bluetooth, Wi-Fi, a mobile phone line, or the like. The external recognition sensor 207 is a sensor that measures an environment around the agent 200. As the external recognition sensor 207, for example, light detection and ranging (LiDAR) or a camera is used.

The position measurement device 208 is a device that measures the position of the agent 200 on a map. For example, a global navigation satellite system (GNSS) is used for processing by the position measurement device 208. The position and orientation of the agent 200 on the map may be calculated based on a simultaneous localization and mapping (SLAM) technique using LiDAR or a camera instead of the position measurement device 208. The posture measurement device 209 is a device that measures the orientation and posture of the agent 200. As the posture measurement device 209, for example, an inertia measurement unit (IMU) or an encoder is used. The control device 210 is a device that converts a velocity command and an orientation command of the agent 200 into actuator output of the agent 200. As the control device 210, a control microcomputer or the like is used.

### <Description of Agents 200>

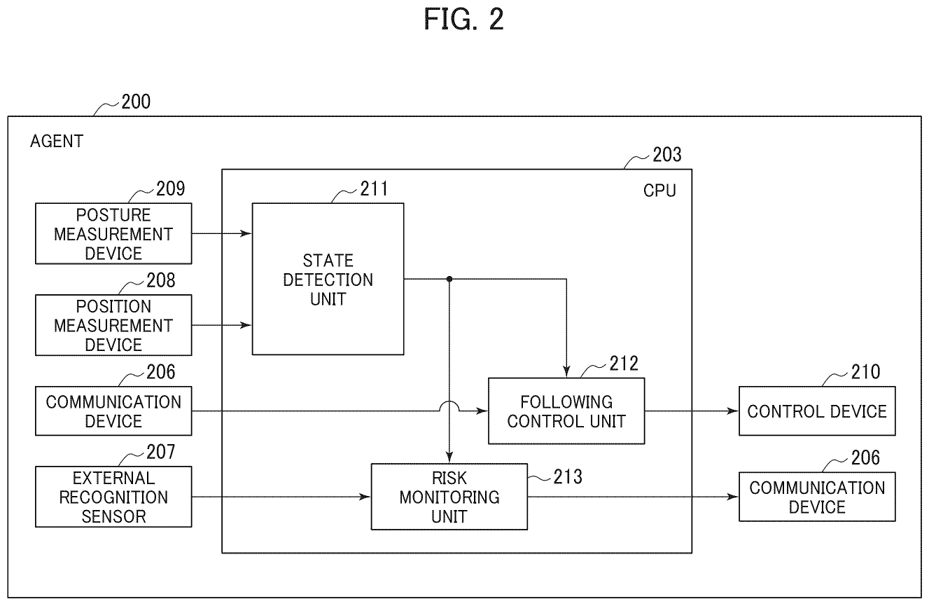

FIG. 2 is a functional block diagram illustrating a system configuration of the agent 200.

As illustrated in FIG. 2, the CPU 203 of the agent 200 includes a state detection unit 211, a following control unit 212, and a risk monitoring unit 213 as a functional configuration. The state detection unit 211 calculates a state (position and orientation) of the agent 200 based on an output value of the posture measurement device 209 and an output value of the position measurement device 208.

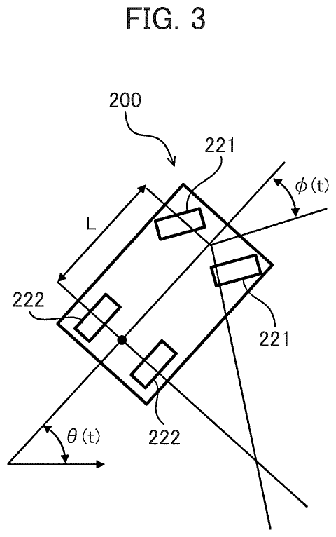

FIG. 3 is an explanatory diagram regarding dimensions and orientation of the agent 200.

In an example illustrated in FIG. 3, the agent 200 is configured as a vehicle and includes front wheels 221, 221 and rear wheels 222, 222. The position and orientation of the agent 200 are represented by a state p(t)=[x(t), y(t), θ(t)] (t indicates time). The orientation θ(t) illustrated in FIG. 3 indicates the orientation of the agent 200 with respect to a predetermined direction. A steering angle φ(t) is an angle indicating a turning direction of the agent 200 with respect to the orientation θ(t). In addition, a length L illustrated in FIG. 3 is a distance between the front wheel 221 and the rear wheel 222 in a front-rear direction. The orientation θ(t), the steering angle φ(t), and the length L are used for processing by the following control unit 212 and the like (see FIG. 2).

The following control unit 212 illustrated in FIG. 2 performs feedback control based on a target route r(t)=[xr(t), yr(t), θr(t)] of the agent 200 acquired from the base station 100 (see FIG. 1) via the communication device 206 and the state p(t)=[x(t), y(t), θ(t)] of the agent 200 acquired from the state detection unit 211 such that a difference between the target route r(t) and the state p(t) is reduced. Then, the following control unit 212 outputs control values such as a steering amount, acceleration and deceleration (accelerator amount and braking amount), and the like to the control device 210.

The control device 210 performs control based on the control values calculated by the following control unit 212 such that the wheels of the agent 200 rotate at a predetermined rotation speed and that the steering rotates at a predetermined rotation angle.

The risk monitoring unit 213 detects another vehicle (vehicle to which the agent 200 does not belong) and a pedestrian around the agent 200 based on sensor information acquired from the external recognition sensor 207, and transmits results of the detection and position information of the agent 200 to the base station 100 (see FIG. 1) via the communication device 206.

### <Description of Base Station 100>

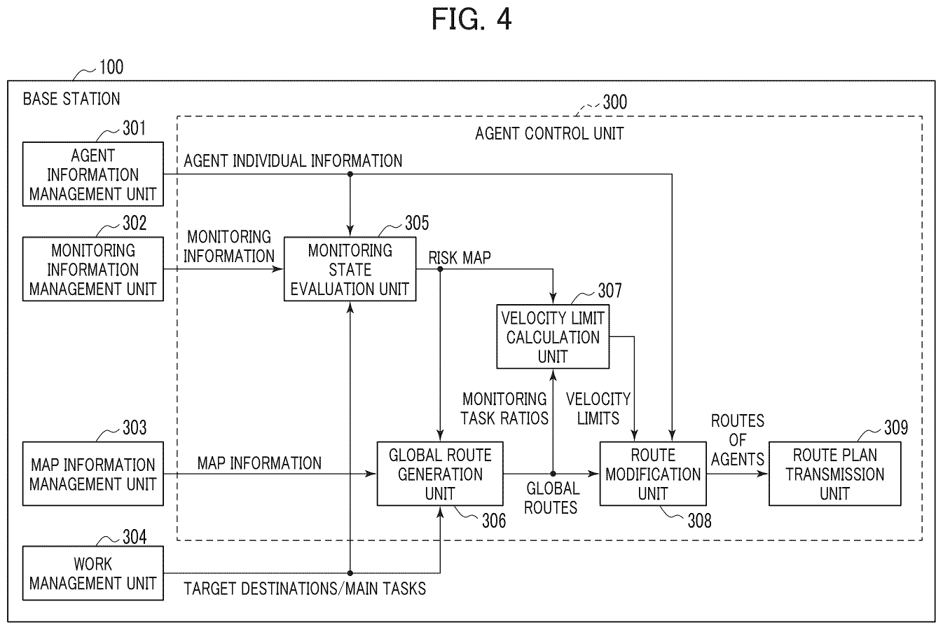

FIG. 4 is a functional block diagram illustrating a system configuration of the base station 100.

As illustrated in FIG. 4, the base station 100 includes an agent information management unit 301, a monitoring information management unit 302, a map information management unit 303, a work management unit 304, and an agent control unit 300. The agent control unit 300 has a function of calculating movement routes of the agents 200 (see FIG. 1). As illustrated in FIG. 4, the agent control unit 300 is connected to the agent information management unit 301, the monitoring information management unit 302, the map information management unit 303, and the work management unit 304. Processing by the agent control unit 300 is executed in the CPU 103 (see FIG. 1) of the base station 100.

### <Agent Information Management Unit 301>

The agent information management unit 301 manages individual information (referred to agent individual information) of the agents 200 that travel in the predetermined region. The agent individual information includes the dimensions of each of the agents 200, a value indicating performance of each of the external recognition sensors 207 (see FIG. 2), and a travelable distance of each of the agents 200. The agent individual information managed by the agent information management unit 301 is not limited thereto and may include the number of passengers that each of the agents 200 can carry and the mass of a package that can be loaded onto each of the agents 200.

As the agent individual information, for example, information collected in advance and stored in the ROM 102 of the base station 100 (see FIG. 1) may be used. Also, the agent individual information managed by a server building (not illustrated) other than the base station 100 may be periodically acquired and updated by the base station 100. The agent individual information is output from the agent information management unit 301 to a monitoring state evaluation unit 305 and a route modification unit 308.

### <Monitoring Information Management Unit 302>

The monitoring information management unit 302 collects the positions of the agents 200 (see FIG. 1) in the predetermined region and position information of a traveling vehicle other than the agents 200 and a pedestrian in chronological order. This monitoring information is collected by transmitting a measured value of the position measurement device 208 (see FIG. 1) of each of the agents 200 and the position information of the surrounding vehicle and the pedestrian extracted from sensor information of the external recognition sensor 207 (see FIG. 1) to the base station 100 via the communication device 206. The monitoring information collected as described above is output from the monitoring information management unit 302 to the monitoring state evaluation unit 305. The method of collecting the monitoring information is not limited thereto, and for example, a fixed sensor (not illustrated) may be attached at an intersection or the like in a town, and information regarding surrounding pedestrians and vehicles acquired from the fixed sensor may be transmitted to the base station 100. As the fixed sensor, for example, a camera or LiDAR is used.

### <Map Information Management Unit 303>

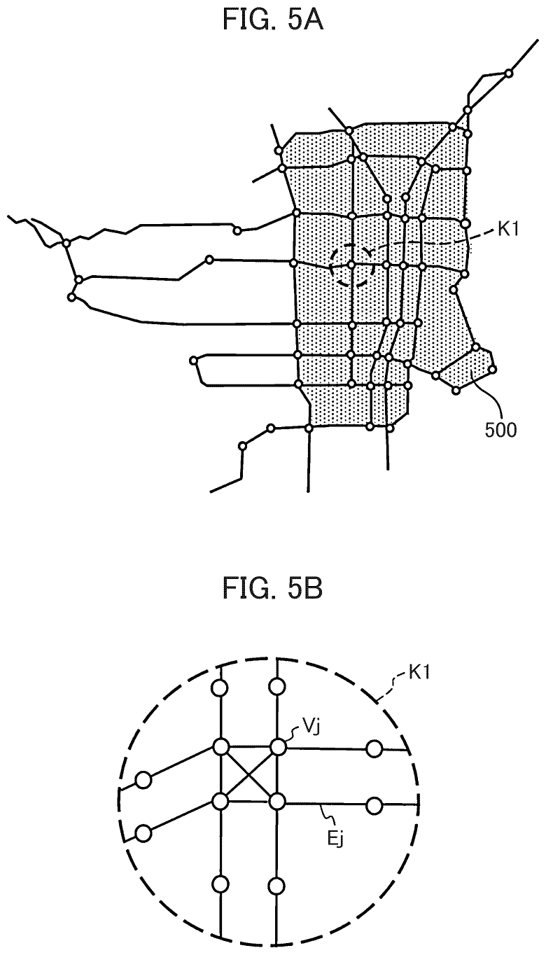

The map information management unit 303 manages map information of a predetermined region 500 (see FIG. 5A). The map information is output from the map information management unit 303 to a global route generation unit 306.

FIG. 5A is an explanatory diagram illustrating an example of the map information.

For example, the map information of the predetermined region 500 (region indicated by dots) illustrated in FIG. 5A is stored in the map information management unit 303 (see FIG. 4) in advance.

FIG. 5B is a partial enlarged view of a region K1 in the map information illustrated in FIG. 5A.

The map information is, for example, represented by a graph G (Vⱼ, Eⱼ) including branches (edges/branches) Eⱼ (j=0, 1, 2, . . . , N) separated by a predetermined distance and extending through the centers of roads, and node points (nodes) Vⱼ at start points and end points of the edges Eⱼ. In the first embodiment, it is assumed that an Eⱼ-th edge at a location on the map and on a road corresponding to the map is a section Eⱼ, and a Vⱼ-th node is a node Vⱼ.

For example, as the map information, a generated map in the predetermined region 500 may be stored in the ROM 102 of the base station 100 (see FIG. 1) in advance, or a map periodically updated by a predetermined map management server (not illustrated) present outside the base station 100 may be received via wireless communication.

### <Work Management Unit 304>

The work management unit 304 illustrated in FIG. 4 manages a target destination and a main task set for each of the agents 200 (see FIG. 1). Target destination information of the agents 200 is managed based on the nodes Vⱼ included in the map information. The target destination information may be position information based on a predetermined coordinate system or may be information of latitudes and longitudes. Each of the main tasks (tasks) is a task regarding a service such as transport of a person or cargo by the agent 200. Examples of the main tasks are transport, traveling not in service, dispatch, and supply (supply of oil) of electric power, but the main tasks are not limited thereto.

For example, a server (not illustrated) that receives a request to dispatch a vehicle or the like from a customer may assign the target destination information and the main task to the agent 200, and periodically transmit the information to the base station 100 via wireless communication.

### <Agent Control Unit 300>

As illustrated in FIG. 4, the agent control unit 300 includes the monitoring state evaluation unit 305, the global route generation unit 306 (route plan generation unit), a velocity limit calculation unit 307, the route modification unit 308, and a route plan transmission unit 309. The agent control unit 300 calculates a route of each of the agents 200 based on the agent individual information, the monitoring information, the map information, and work information (the target destinations and the main tasks) and transmits the results of the calculation to the agents 200.

### <Monitoring State Evaluation Unit 305>

The monitoring state evaluation unit 305 generates a risk map indicating a monitoring evaluation index for each location based on the agent individual information acquired from the agent information management unit 301, the monitoring information acquired from the monitoring information management unit 302, and information indicating the target destinations and the main tasks of the agents 200 acquired from the work management unit 304. Each of the monitoring evaluation indices indicates a value whether or not a monitoring state at each location in the predetermined region 500 (see FIG. 5A) is good.

The risk map described above is a map in which each of values of the monitoring evaluation indices is associated with each of the locations in the predetermined region 500. The risk map may not be the graph (see FIG. 5B) including the edges Ej and the nodes Vj, and may be, for example, grid data obtained by dividing the predetermined region 500 (see FIG. 5A) into grid regions.

For example, as the value of a monitoring evaluation index is higher, a risk (risk of contact with another vehicle or a person, or the like) at a corresponding location is higher and monitoring at the location is likely to be more required. On the other hand, as the value of the monitoring evaluation index is lower, the corresponding location is well monitored and a risk at the location is likely to be lower. As the number of pedestrians and vehicles that have passed through the section Eⱼ within a predetermined time ΔT is larger, the value of the monitoring evaluation index is higher. In addition, as the number of vehicles (i.e., the agents 200) that have passed through the section Eⱼ within the predetermined time ΔT and are responsible for a monitoring task is larger, the value of the monitoring evaluation index is lower. The predetermined time ΔT is, for example, a cycle at which the calculation of the monitoring evaluation index is repeated.

In the first embodiment, the monitoring state evaluation unit 305 evaluates a monitoring state of each of the sections Eⱼ associated with the map information. A monitoring evaluation index Cₘⱼ(T+ΔT) at the edge Eⱼ at a time (T+ΔT) is, for example, as following Equation 1, calculated by multiplying a product of a predetermined coefficient αₒⱼ, a coefficient αₘⱼ, a coefficient αₑₙᵥⱼ, and a coefficient αₑₛₚ by a monitoring evaluation index Cₘⱼ(T) at a time T. The coefficient αₒⱼ is a value defined by the number of vehicles and pedestrians that have passed through the section Eⱼ within the predetermined time ΔT. The coefficient αₘⱼ is a value defined by the number of agents 200 that have passed through the section Eⱼ within the predetermined time ΔT and are responsible for the monitoring task. The coefficient αₑₙᵥⱼ is a value in which a road surface environment, a traffic accident rate, and the like in the section Et is reflected. The coefficient αₑₛₚ is a coefficient (forgetting coefficient) in which elapse of time is reflected. Note that the subscript “m” added to the monitoring evaluation index Cₘⱼ(T) and the coefficient αₘⱼ means monitoring.

$$[ Equation 1 ]$$

$${c}_{mj} ( T + Δ T ) = {α}_{oj} \cdot {α}_{mj} \cdot {α}_{envj} \cdot {α}_{esp} \cdot {c}_{mj} ( T ) \qquad ( 1 )$$

### <Description of Monitoring Evaluation Indices>

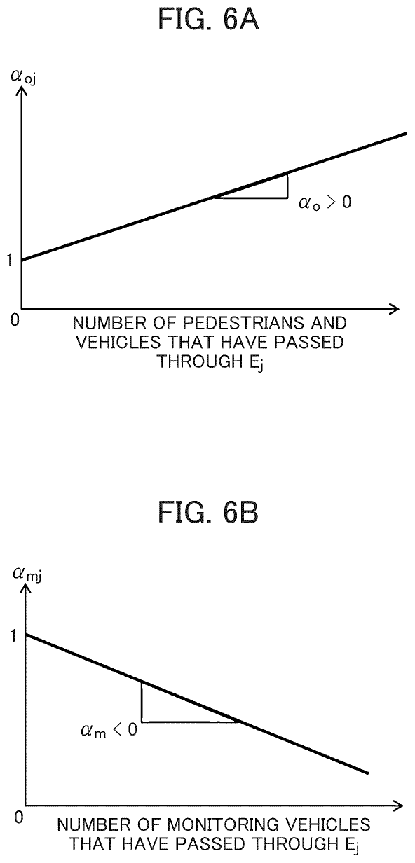

FIG. 6A is an explanatory diagram of the coefficient αₒⱼ used for calculation of the monitoring evaluation indices.

In FIG. 6A, the horizontal axis indicates the number of pedestrians and vehicles that have passed through the section Eⱼ within a predetermined time, and the vertical axis indicates the value of the coefficient αₒⱼ. As illustrated in FIG. 6A, the coefficient αₒⱼ is, for example, expressed as a linear function with an intercept of 1 and a positive slope aₒ. That is, as the number of pedestrians and vehicles that have passed through the section Eⱼ is greater, a larger value is set as the coefficient αₒⱼ.

FIG. 6B is an explanatory diagram of the coefficient αₘⱼ used for calculation of the monitoring evaluation indices.

In FIG. 6B, the horizontal axis indicates the number of monitoring vehicles (i.e., the agents 200 that are responsible for the monitoring task) that have passed through the section Eⱼ within the predetermined time, and the vertical axis indicates the value of the coefficient αₘⱼ. As illustrated in FIG. 6B, the coefficient αₘⱼ is, for example, expressed as a linear function with an intercept of 1 and a negative slope aₘ. That is, as the number of monitoring vehicles that have passed through the section Eⱼ is larger, a smaller value is set as the coefficient αₘⱼ. The coefficient αₒⱼ (see FIG. 6A) and the coefficient αₘⱼ (see FIG. 6B) may not need to be linear functions, and may be changed exponentially. Also, as the coefficient αₒⱼ (see FIG. 6A) and the coefficient αₘⱼ (see FIG. 6B), table data generated in advance based on statistical data regarding a vehicle traffic volume and the number of traffic accidents may be used.

The coefficient αₑₙᵥⱼ included in the Equation (1) described above is set based on a traffic accident rate based on a preliminary survey or the like and whether or not a visibility based on a preliminary survey or the like is good. For example, for a location, such as an intersection, where the number of traffic accidents is large based on the preliminary survey, the coefficient αₑₙᵥⱼ is set to a value greater than 1, and a monitoring evaluation index is set to increase in value over time. In addition, for each of sections where safety is high, for example, a road with good visibility and a section where a fence is provided at a boundary between a sidewalk and a vehicular road, the coefficient αₑₙᵥⱼ is set to be low (e.g., a value not greater than 1), and a monitoring evaluation index is set to decrease over time. By including the coefficient αₑₙᵥⱼ that depends on the location in the monitoring evaluation indices, it is possible to reflect the necessity of monitoring according to not only pedestrian traffic volumes and vehicle traffic volumes but also a situation at a site.

In addition, the coefficient αₑₛₚ based on elapse of time is set using a positive constant such that a monitoring evaluation index increases over time. By setting the monitoring evaluation indices, it is possible to generate a risk map in which monitoring evaluation indices are high for a section with a high pedestrian traffic volume and a high vehicle traffic volume, a section with a high number of traffic accidents, and a section with a small number of monitoring vehicles. Note that the values of the monitoring evaluation indices for the sections in the risk map change over time.

### <Global Route Generation Unit 306>

The global route generation unit 306 (route plan generation unit) illustrated in FIG. 4 generates global routes (route plan) of the agents 200 based on the monitoring evaluation indices and work management information including destinations of the agents 200 and a type of a task. Specifically, the global route generation unit 306 generates the global routes of the agents 200 (see FIG. 1) based on a graph-based search method such as the Dijkstra method. The “global routes” mean brief routes to predetermined target destinations at which the agents 200 will arrive.

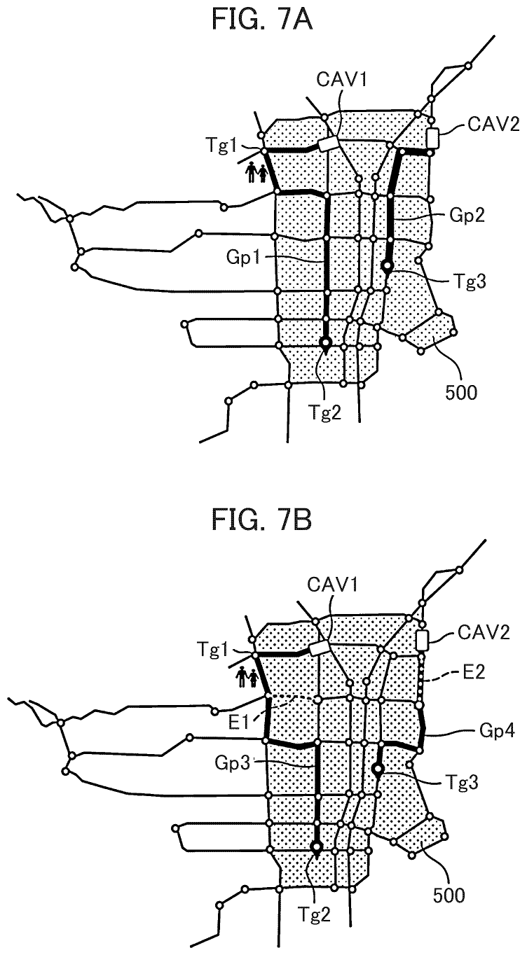

FIG. 7A is an explanatory diagram illustrating routes of agents according to a comparative example.

Reference signs CAV1 and CAV2 illustrated in FIG. 7A indicate vehicles that are an example of the agents 200 (see FIG. 1). Hereinafter, the word “agent” is also used for these signs CAV1 and CAV2. FIG. 7A illustrates a route plan according to the comparative example in which only the lengths of the routes are considered as conventional techniques. That is, a shortest route Gp1 is generated at the time when the agent CAV1 moves to a target destination Tg2 after the agent CAV1 moves to a target destination Tg1 and picks up a person. In addition, a shortest route Gp2 that extends to a target destination Tg3 to which the other agent CAV2 moves is generated.

### <Description of Operation of Global Route Generation Unit 306>

FIG. 7B is an explanatory diagram illustrating global routes of the agents in the agent control system according to the first embodiment.

For example, it is assumed that the agents CAV1 and CAV2 that are present in the predetermined region 500 perform tasks such as transport, traveling not in service, and charging while moving around (i.e., monitoring). The “moving around” described above means that the agents CAV1 and CAV2 detects people, other vehicles, and the like around the agents CAV1 and CAV2 by using the external recognition sensor 207 (see FIG. 1) while moving in the predetermined region 500 based on the route plan transmitted from the agent control unit 300 (see FIG. 4), and transmits the results of the detection as monitoring information to the monitoring information management unit 302 (see FIG. 4). After performing a task of dispatching to the target destination Tg1, the agent CAV1 performs a transport task of picking up a passenger and moving to the target destination Tg2. In this case, it is assumed that a monitoring evaluation index for a section E1 illustrated in FIG. 7B is relatively high. The agent CAV1 that carries the passenger and moves performs the transport task. However, if the shortest route is to be selected, a route Gp1 that extends through the section E1 is selected.

On the other hand, in the first embodiment, the agent CAV1 takes a detour and selects a route Gp3 extending to the target Tg2 such that a risk is low. This increases reliability when the agent CAV1 performs the transport task. The agent CAV1 monitors a traveling route thereof while performing the transport task.

In addition, it is assumed that the agent CAV2 illustrated in FIG. 7B does not carry a passenger and travels to the target Tg3 in order to supply electric power. Furthermore, it is assumed that a monitoring evaluation index for a section E2 in the middle is relatively high. In this case, in the first embodiment, by assigning a monitoring task to the agent CAV2, a monitoring state in a section with a high monitoring evaluation index in the predetermined region 500 is improved. Specifically, the agent CAV2 selects a route Gp4 that is different from the shortest route Gp2 illustrated in FIG. 7A and extends through the section E2. Then, the agent CAV2 uses the external recognition sensor 207 (see FIG. 2) to recognize surroundings around the section E2, improves the monitoring evaluation index for the section E2 based on the Equation (1) described above, and travels toward the target destination Tg3.

As described above, in the first embodiment, each of the agents CAV1 and CAV2 performs both the monitoring task and the main task (transport, dispatch, traveling not in service, supply of electric power, or the like). Therefore, an agent (not illustrated) dedicated for monitoring and a fixed sensor (not illustrated) do not need to be disposed in the predetermined region 500 (see FIG. 5A), and it is possible to improve the efficiency of the entire system and reduce the cost.

<Monitoring Task Ratios βᵢ>

In order to implement the route plan described above, in the first embodiment, the global route generation unit 306 (see FIG. 4) gives the monitoring task to each of the agents 200 according to the type of the main task and performance (sensing range, resolution, environmental resistance, and the like) of the external recognition sensor 207 (see FIG. 2) included in each of the agents 200. The ratio of the importance of monitoring to the main task (task) is referred to as a monitoring task ratio βᵢ (i is an identification number of the agent 200).

For example, as the monitoring task ratio βᵢ is higher, a route for which a monitoring evaluation index for a surrounding environment is relatively higher and through which the agent 200 will pass is selected. In addition, as the monitoring task ratio Bi is lower, a highly safe route for which a monitoring evaluation index is lower is selected. As described above, the monitoring evaluation indices are calculated for the respective sections Eⱼ (see FIG. 5B) of the predetermined region 500 (see FIG. 5A). Meanwhile, monitoring task ratios βᵢ are individually set such that the monitoring task ratios βᵢ are associated with the plurality of agents 200 on a one-to-one basis.

<Method of Setting Monitoring Task Ratios βᵢ>

Each monitoring task ratio βᵢ is determined based on the type of the main task of the agent 200 and the sensor performance (sensing range, resolution, environmental resistance, and the like) of the external recognition sensor 207 (see FIG. 2) included in each of the agents 200. The monitoring task ratio Bi may be determined based on a factor other than these factors. For example, the travelable distance of the agent 200 may be considered, and environmental factors such as weather and a time zone may be added. Specifically, for example, as the travelable distance of the agent 200 is longer, the monitoring task ratio βᵢ may be set to be higher. In addition, the monitoring task ratio βᵢ in the case of bad weather such as rain or snow may be set to be higher than that in the case of sunny or cloudy weather. Other than that, the monitoring task ratio βᵢ may be set to be higher during a night time period than that in other time periods.

Data specifying the main task assigned to the agent 200 is output from the work management unit 304 (see FIG. 4) to the global route generation unit 306. Examples of the type of the main task of the agent 200 are transport, traveling not in service, dispatch, supply of electric power, and entering in a garage. In the case of tasks (traveling not in service, dispatch, supply of electric power, and entering in a garage) in which the agent 200 does not carry a passenger and cargo among the tasks described above, the global route generation unit 306 increases the monitoring task ratio βᵢ and increases the monitoring task assigned to the agent 200. That is, the global route generation unit 306 (route plan generation unit) sets the monitoring task ratio βᵢ in a case where the main task (task) is traveling not in service, dispatch, or movement for supply of electric power is higher than the value of the monitoring task ratio βᵢ in a case where the main task is transport of a person or a package.

On the other hand, for the agent 200 to which the transport task is assigned as the main task, the global route generation unit 306 lowers the monitoring task ratio βᵢ and reduces the ratio of the monitoring task assigned to the agent 200. The main task of the agent 200 may be switched, for example, from “dispatch” to “transport” in the middle. The monitoring task ratio βᵢ also changes with changes in the travelable distance of the agent 200, weather, and a time zone, in addition to the timing of switching the main task.

The monitoring task ratio βᵢ is, for example, set to a value determined for each main task in advance. In addition, in a case where the external recognition sensors 207 (see FIG. 2) included in the respective agents 200 are different for each of the agents 200, the global route generation unit 306 (route plan generation unit) sets the monitoring task ratios βᵢ to values that are higher as the performance (sensing ranges, resolution, durability, and the like) of the external recognition sensors 207 is higher. Specifically, the monitoring task ratios βᵢ of the agents 200 may be calculated by setting additional values of the monitoring task ratios βᵢ based on the external recognition sensors 207 (see FIG. 2) for each of the agents 200 in advance and adding the additional values to a predetermined monitoring task ratio based on the type of the main task.

### <Method of Calculating Weight for Section Eⱼ in Route Calculation>

A weight wⱼ for the section Et that is used for calculation of a route of each of the agents 200 is, for example, calculated based on the following Equation (2) using a weight w_{dj} for a route length of the section Eⱼ and a weight wₘⱼ for the magnitude of the monitoring evaluation index for the section Eⱼ.

$$[ Equation 2 ]$$

$${w}_{j} = {w}_{dj} + {w}_{mj} ( {c}_{mj} , {β}_{i} ) \qquad ( 2 )$$

For example, the global route generation unit 306 (see FIG. 4) sets the global routes of the agents 200 such that a sum of the weights we in a case where the agents 200 move to a predetermined target destination is minimized. The weight w_{dj} for the route length that is included in Equation (2) is set by measuring the route length of the section Eⱼ from the map information. As the distance of the section Eⱼ is longer, the value of the weight w_{dj} is greater. In addition, the weight wₘⱼ for the magnitude of the monitoring evaluation index is, for example, calculated based on the monitoring task ratio Bi and the monitoring evaluation index Cₘⱼ.

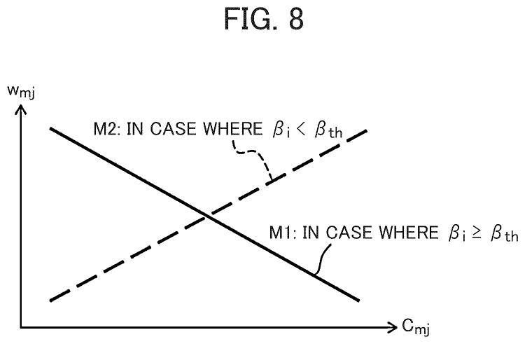

FIG. 8 is an explanatory diagram illustrating a relationship between a monitoring evaluation index Cₘⱼ and a weight Wₘⱼ.

The horizontal axis illustrated in FIG. 8 indicates the monitoring evaluation index Cₘⱼ for the section Eⱼ. In addition, the vertical axis illustrated in FIG. 8 indicates the weight wₘⱼ for the monitoring evaluation index Cₘⱼ. For example, in a case where the monitoring task ratio βᵢ is equal to or greater than a predetermined value βₜₕ, as the monitoring evaluation index Cₘⱼ is greater, the weight wₘⱼ is set to be lower (see a solid straight line M1 illustrated in FIG. 8). That is, the global route generation unit 306 (route plan generation unit) generates a route plan such that as the monitoring task ratio βᵢ is higher, the agent 200 is caused to travel on a route with a relatively higher monitoring evaluation index Cₘⱼ. Therefore, a route that is poorly monitored is preferentially monitored by the agent 200 with a relatively high monitoring task ratio βᵢ. The predetermined value βₜₕ is a threshold for a monitoring task ratio βᵢ that serves as a criterion for determining which one of the straight lines M1 and M2 illustrated in FIG. 8 is to be used in a case where the global route generation unit 306 sets the weight wₘⱼ, and is set in advance.

In addition, in a case where the monitoring task ratio βᵢ is smaller than the predetermined threshold βₜₕ, as the monitoring evaluation index Cₘⱼ is larger, the weight wₘⱼ is set to be larger (see the broken straight line M2 illustrated in FIG. 8). That is, the global route generation unit 306 (see FIG. 4) sets the weight wₘⱼ for a high-risk route with a large monitoring evaluation index Cₘⱼ to be large. Therefore, for example, the agent 200 that transports a person or cargo can be prevented from traveling on a route that is poorly monitored.

The method of calculating the weight wₘⱼ is not limited to the example illustrated in FIG. 8. For example, the slope of the straight line indicating the monitoring evaluation index Cₘⱼ and the weight wₘⱼ may be a function of the monitoring task ratio βᵢ. In addition, the weight wₘⱼ may exponentially change with respect to the monitoring evaluation index Cₘⱼ. Furthermore, the equation for calculation of the weight wⱼ is not limited to Equation (2). For example, the global route generation unit 306 may use the following Equation (3) in order to increase an effect of the monitoring task ratio βᵢ. The range of the monitoring task ratio βᵢ included in Equation (3) is 0≤βᵢ≤1.

$$[ Equation 3 ]$$

$${w}_{j} = ( 1 - {β}_{i} ) \cdot {w}_{dj} + {β}_{i} \cdot {w}_{mj} ( {c}_{mj} , {β}_{i} ) ( 0 \leq β i \leq 1 ) \qquad ( 3 )$$

The global route generation unit 306 (see FIG. 4) uses the weight wⱼ for the section Eⱼ calculated in the above-described procedure to calculate the global route of each of the agents 200 by a graph-based search method such as the Dijkstra method.

### <Velocity Limit Calculation Unit 307>

The velocity limit calculation unit 307 illustrated in FIG. 4 calculates a velocity limit for each of the agents 200 based on the monitoring evaluation indices Cₘⱼ calculated by the monitoring state evaluation unit 305 (see FIG. 4) and the monitoring task ratios βᵢ calculated by the global route generation unit 306 (see FIG. 4). A method of calculating the velocity limits will be described.

### <Route Modification Unit 308>

The route modification unit 308 illustrated in FIG. 4 modifies the route of each of the agents 200. That is, the route modification unit 308 refers to the global routes calculated by the global route generation unit 306 (see FIG. 4) and generates a target route for each of the agents 200 to cause the agent 200 to follow the target routes by using the velocity limit calculated by the velocity limit calculation unit 307 as a constraint. For route modification, for example, by using a model predictive control framework, it is possible to formulate the velocity constraint explicitly.

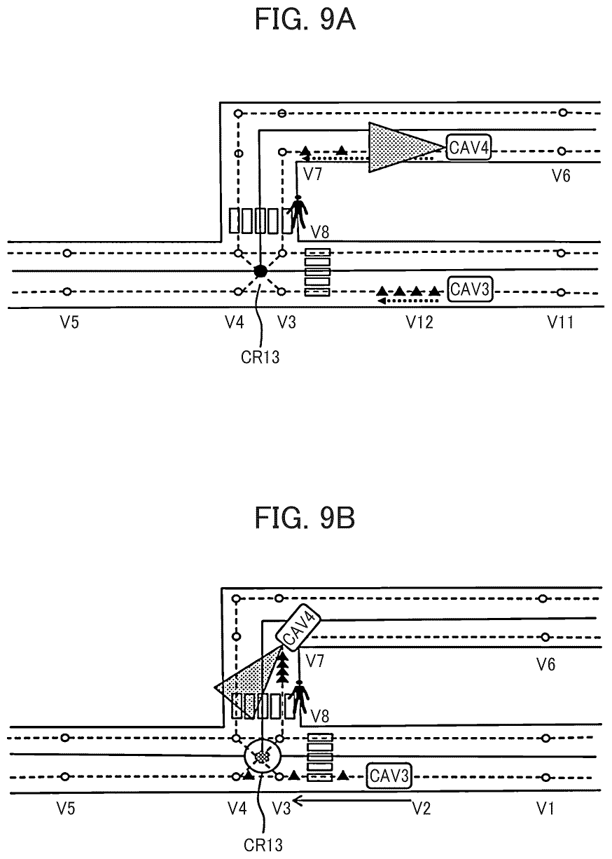

FIG. 9A is an explanatory diagram illustrating a traffic condition when a time t=k in an area in the predetermined region.

In an example illustrated in FIG. 9A, an external recognition sensor 207 (see FIG. 2) with a wide sensing range is included in an agent CAV4 (see the triangle with dots). In addition, in FIG. 9A, a chronological position of an agent CAV3 and a chronological position of the agent CAV4 for each calculation step are indicated by black triangles.

When the time t=k (k is a calculation step), as illustrated in FIG. 9A, the agent CAV3 performs a transport task and the other agent CAV4 performs a task of traveling not in service. In addition, it is assumed that both the agents CAV3 and CAV4 pass through an intersection CR13 and are moving toward a node V5. It is assumed that the agents CAV3 and CAV4 share the same value as the monitoring evaluation index for the section Eⱼ within the intersection CR13.

### <Description of Operation of Route Modification Unit 308>

In a case where the monitoring evaluation index for the intersection CR13 is relatively large in a state illustrated in FIG. 9A, it is risky for the agent CAV3, which is performing a transport task of carrying a person or cargo, to pass through. In the first embodiment, the risk is reduced by imposing a velocity constraint on the agent CAV3, delaying the arrival time at the intersection CR13, and reducing the speed at the intersection CR13 at the time of passing. Meanwhile, in a case where the agent CAV4 that includes the external recognition sensor 207 with high sensing performance and travels while being not in service passes through the intersection CR13, there is no need to worry about damage to a package and the like compared with the agent CAV3, and the risk is low, so there is no particular need for the velocity limit calculation unit 307 (see FIG. 4) to impose a velocity constraint.

FIG. 9B is an explanatory diagram illustrating a traffic condition when the time t=k+1 in the area in the predetermined region.

For example, in the condition illustrated in FIG. 9A (the time t=k), if the state of the intersection CR13 is sensed by the external recognition sensor 207 of the agent CAV4 and a monitoring evaluation index Cₘ₁₃ for the intersection CR13 is improved, the risk at the intersection CR13 is reduced. In a case where the value of the monitoring evaluation index Cₘ₁₃ is improved as described above, the risk when the agent CAV3 passes through the intersection CR13 is reduced and thus the velocity limit calculation unit 307 (see FIG. 4) removes the velocity constraint imposed on the agent CAV3.

In addition, in a case where a pedestrian or another vehicle (vehicle that does not belong to an agent 200) is present at the intersection CR13, the velocity limit calculation unit 307 (see FIG. 4) may impose a constraint on the agent CAV4 in order to avoid collision with the obstacle. Therefore, the agent CAV4 can generate a route that avoids pedestrians and vehicles, and generate a route on which the agent CAV4 decelerates or stops in front of a pedestrian and a vehicle.

### <System Formulation Using Model Predictive Control>

In a case where a vector including the position and orientation of an i-th agent 200 is pᵢ, a node on a global route Gpi of the i-th agent 200 calculated in the global route generation unit 306 (see FIG. 4) is Vᵢ, and a virtual target position is rᵢ, the following Equations (4a) and (4b) are obtained. In addition, a deviation between the vector pᵢ and the virtual target position rᵢ is eᵢ, and defined as shown in the following Equation (4c). Note that k means a calculation step (time).

$$[ Equation 4 ]$$

$${p}_{i} ( k ) = {[ \begin{matrix}{x}_{i} ( k ) & {y}_{i} ( k ) & {θ}_{i} ( k )\end{matrix} ]}^{T} \qquad ( 4 a )$$

$$[ Equation 5 ]$$

$${r}_{i} ( k ) = {[ \begin{matrix}{xr}_{i} ( k ) & y {r}_{i} ( k ) & θ {r}_{i} ( k )\end{matrix} ]}^{T} \qquad ( 4 b )$$

$$[ Equation 6 ]$$

$${e}_{i} ( k ) := {p}_{i} ( k ) - {r}_{i} ( k ) \qquad ( 4 c )$$

A motion model of the agent 200 is, for example, formulated as shown in Equation (5). A velocity vᵢ and a steering angle φᵢ included in Equation (5) correspond to a control command of the agent 200. In addition, L is a distance between the front wheels 221 and the rear wheels 222 of the agent 200 (see FIG. 3) in the front-rear direction.

$$[ Equation 7 ]$$

$$\begin{matrix}\frac{{dp}_{i}}{dt} = \frac{d}{dt} [ \begin{matrix}{x}_{i} \\ {y}_{i} \\ {θ}_{i}\end{matrix} ] \\ = [ \begin{matrix}{v}_{i} cos {θ}_{i} \\ {v}_{i} sin {θ}_{i} \\ \frac{{v}_{i}}{L} tan {ϕ}_{i}\end{matrix} ] \\ = f ( {p}_{i} , {u}_{i} )\end{matrix} \qquad ( 5 )$$

In addition, a control command vector uᵢ that includes the velocity vᵢ and the steering angle φᵢ of the i-th agent 200 is defined as shown in Equation (6).

$$[ Equation 8 ]$$

$${u}_{i} ( k ) = {[ \begin{matrix}{v}_{i} & {ϕ}_{i}\end{matrix} ]}^{T} \qquad ( 6 )$$

Furthermore, by discretizing Equation (5) with a predetermined sampling period Δt, the following Equation (7) is obtained.

$$[ Equation 9 ]$$

$${p}_{i} ( k + 1 ) = {p}_{i} ( k ) + Δ t \cdot f ( {p}_{i} ( k ) , {u}_{i} ( k ) ) \qquad ( 7 )$$

The route modification unit 308 (see FIG. 4) calculates a command vector uᵢ(k) such that a deviation eᵢ(k) between the position pᵢ(k) of the agent 200 and a virtual target position rᵢ(k) on the global route Gpi at each time k is small.

In addition, by the formulation using the model predictive control, Qᵢ and Rᵢ are set as weight matrixes, Np is set as a prediction step, and the following Equation (8) regarding an evaluation function J is obtained. Equation (8) is used for optimizing a route from a predetermined time k0 to a time (Np+k0−1).

$$[ Equation 10 ]$$

$$J = {\sum }_{i = 1}^{N} {J}_{i} = {\sum }_{i = 1}^{N} {\sum }_{k = {k}_{0}}^{{N}_{p} - {k}_{0} + 1} {( {r}_{i} ( {k}_{0} ) - {p}_{i} ( k ) )}^{T} {Q}_{i} ( {r}_{i} ( {k}_{0} ) - {p}_{i} ( k ) ) + {u}_{i}^{T} ( k ) {R}_{i} {u}_{i} \qquad ( 8 )$$

In the model predictive control, at each time k, optimization control input uᵢ(k) is calculated to minimize an evaluation function J expressed by Equation (8). By substituting the optimization control input uᵢ(k) obtained in this manner into Equation (7), the position (x(k), y(k)) and orientation θ(k) of the agent 200 at each time k are calculated. Then, time-series data (data from the time k0 to the Np step) specified by the position (x(k), y(k)) and the orientation θ(k) is generated.

### <Velocity Constraint Condition According to Monitoring Task Ratio Rᵢ>

The velocity limit calculation unit 307 illustrated in FIG. 4 calculates, for example, a velocity constraint expressed by the following Inequalities (9) based on the monitoring task ratio βᵢ and the monitoring evaluation index Cₘⱼ for the section Eⱼ. Therefore, a constraint condition is given to the predetermined evaluation function J, and a predetermined constraint is imposed on the velocity of the agent 200.

$$[ Inequalities 11 ]$$

$$\{ \begin{matrix}\vert {v}_{i} \vert \leq {v}_{slow} & {c}_{mj} > {c}_{th} ⋂ {β}_{i} < {β}_{th} \\ \vert {v}_{i} \vert \leq {v}_{m ax} & otherwise\end{matrix} \qquad ( 9 )$$

That is, in a case where the monitoring evaluation index Cₘⱼ is higher than a predetermined threshold Cₜₕ, and the monitoring task ratio βᵢ is less than the predetermined value βₜₕ, the velocity vᵢ of the agent 200 is suppressed to a velocity equal to or lower than a predetermined velocity limit v_{slow}. In addition, in other cases, the velocity vᵢ of the agent 200 is suppressed to a velocity equal to or lower than a predetermined upper velocity limit vₘₐₓ. It is assumed that the value of the velocity limit v_{slow} is lower than the upper velocity limit vₘₐₓ. In a case where the monitoring task ratio βᵢ is less than the predetermined value βₜₕ, the velocity limit calculation unit 307 (see FIG. 4) sets the velocity limit v_{slow} such that the velocity limit v_{slow} when the agent 200 is caused to travel in a region for which the monitoring evaluation index Cₘⱼ is relatively high is lower than the velocity limit (upper velocity limit vₘₐₓ) in a case where the monitoring task ratio βᵢ is more than the predetermined value βₜₕ. By using the above-described Inequalities (9), it is possible to set the agent 200 with a low monitoring task ratio βᵢ to travel at a low speed in an area with a high monitoring evaluation index Cₘⱼ.

Then, the route modification unit 308 modifies the traveling route of the agent 200 based on the predetermined velocity limit and the monitoring information to suppress a velocity at which the agent 200 travels to a velocity equal to or lower than the velocity limit and avoid contact with an object around the agent 200.

The method of providing the velocity constraint is not limited to the conditions described above. For example, in order to impose a velocity constraint before the agent 200 that is performing a transport task enters an area with a high monitoring evaluation index Cₘⱼ, the velocity limit calculation unit 307 (see FIG. 4) may give a velocity constraint to each of the agents 200 based on the monitoring evaluation index Cₘⱼ for the next section after the section in which the agent 200 travels. It is desirable that the velocity limit v_{slow} in this case be a velocity at which it can sufficiently handle a sudden rushing out into a road or the like. In addition, as the upper velocity limit vₘₐₓ, for example, a lower value out of the maximum velocity of the agent 200 and a legal speed is used.

### <Constraint Regarding Avoidance of Obstacle>

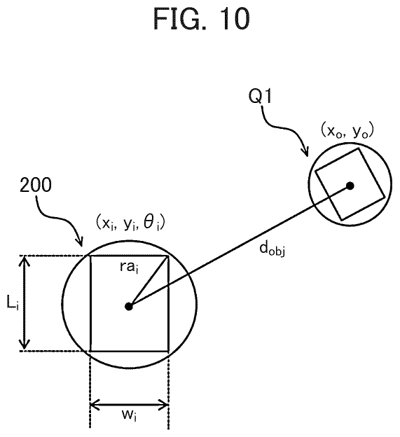

FIG. 10 is an explanatory diagram illustrating a condition for avoiding contact with an obstacle.

In order for the agent 200 to avoid contact with vehicles (including the other agents 200) and pedestrians, for example, a constraint for a relative distance between the agent 200 and another object may be given to the above-described evaluation function J. As illustrated in FIG. 10, in a case where the width of the i-th agent 200 is wᵢ and the length of the i-th agent 200 is Li, the agent 200 can be surrounded by a circle with a radius rai as shown in Equation (10)

$$[ Equation 12 ]$$

$${ra}_{i} = \sqrt{{( {w}_{i} / 2 )}^{2} + {( {L}_{i} / 2 )}^{2}} \qquad ( 10 )$$

In addition, a distance between an obstacle Q1 that may come into contact with the i-th agent 200 and the agent 200 is expressed by the following Equation (11).

$$[ Equation 13 ]$$

$${d}_{obj} = \sqrt{{( {x}_{i} - {x}_{o} )}^{2} + {( {y}_{i} - {y}_{o} )}^{2}} \qquad ( 11 )$$

Therefore, in a case where the constraint condition expressed by the following Inequality (12) is established, it is possible to avoid contact between the i-th agent 200 and the obstacle Q1. In this case, r_{obj} indicates the size of the obstacle Q1 such as a pedestrian or another vehicle. As the value of r_{obj}, for example, a value calculated by the external recognition sensor 207 (see FIG. 2) may be used, or a value set in advance regardless of the type of the obstacle Q1 may be used.

$$[ Inequality 14 ]$$

$${d}_{ij} > {ra}_{i} + {r}_{obj} \qquad ( 12 )$$

The route modification unit 308 (see FIG. 4) calculates a control input string U(k)=[U1(k) . . . UN(k)] that minimizes the evaluation function J expressed by Equation (8) under the constraint condition expressed by Inequality (12). Therefore, it is possible to calculate an efficient movement route while avoiding contact of each of the agents 200 with another vehicle and a pedestrian.

### <Route Plan Transmission Unit 309>

The route plan transmission unit 309 illustrated in FIG. 4 transmits data of a route plan to each of the agents 200. That is, the route plan transmission unit 309 transmits a route calculated by the route modification unit 308 (see FIG. 4) to each of the agents 200 via wireless communication. Each of the agents 200 performs predetermined following control based on the route transmitted by the route plan transmission unit 309.

### <Flowchart of Agent Control Unit>

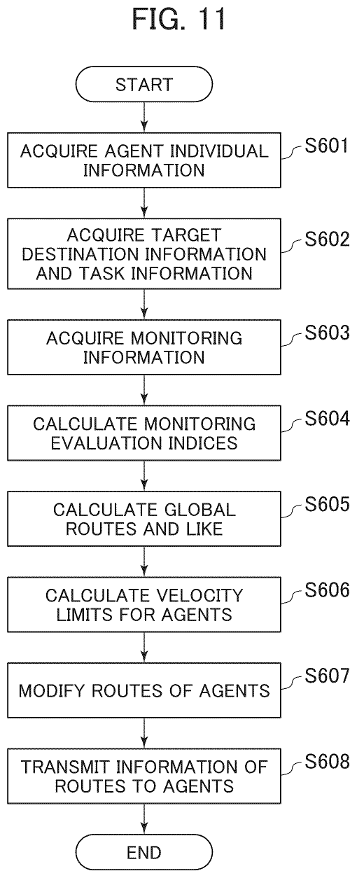

FIG. 11 is a flowchart illustrating an operation procedure of the agent control unit (see also FIG. 4 as appropriate).

First, in step S601, the agent control unit 300 acquires, from the agent information management unit 301, the individual information (agent individual information) of the agents 200 to be controlled.

Next, in step S602, the agent control unit 300 acquires target destination information of the agents 200 and task information from the work management unit 304.

In step S603, the agent control unit 300 acquires, from the monitoring state evaluation unit 305, monitoring information including the positions of the agents 200 and current positions of a pedestrian and a traveling vehicle within the predetermined region 500.

In step S604, the agent control unit 300 causes the monitoring state evaluation unit 305 to calculate a monitoring evaluation index for each of the sections in the predetermined region 500 (monitoring state evaluation processing). That is, the agent control unit 300 calculates the monitoring evaluation index for each of the sections based on the positions of the agents 200 and the current positions of the pedestrian and the traveling vehicle in the predetermined region 500 that have been acquired from the monitoring state evaluation unit 305.

In step S605, the agent control unit 300 causes the global route generation unit 306 to calculate global routes of the agents 200 and calculate monitoring task ratios βᵢ (route plan generation processing). That is, the agent control unit 300 calculates the global route Gpi and the monitoring task ratio βᵢ of each of the agents 200 based on the monitoring evaluation index for each of the sections calculated in step S604, the map information acquired by the map information management unit 303, and the target destination information and main task information of the agents 200 acquired by the work management unit 304. For an agent 200 for which a global route has already been calculated, a result of previously calculating the global route may be used as it is in order to reduce the calculation time.

Next, in step S606, the agent control unit 300 causes the velocity limit calculation unit 307 to calculate a velocity limit for each of the agents 200. That is, the agent control unit 300 calculates a velocity limit for each of the agents 200 based on a risk map indicating the monitoring evaluation index for each location calculated by the monitoring state evaluation unit 305 and the monitoring task ratios βᵢ calculated by the global route generation unit 306.

In step S607, the agent control unit 300 causes the route modification unit 308 to modify the routes of the agents 200. That is, the agent control unit 300 calculates the routes between nodes based on the velocity limits for the agents 200 calculated by the velocity limit calculation unit 307 and information of obstacles around the agents 200.

In step S608, the agent control unit 300 causes the route plan transmission unit 309 to transmit information of the routes calculated in step S607 to each of the agents 200 via wireless communication (route plan transmission processing). Each of the agents 200 that have received the information of the routes from the base station 100 (see FIG. 1) performs following control within the predetermined region 500 based on the information of the routes.

The agent control unit 300 performs the above-described process repeatedly to control each of the agents 200 within the predetermined region 500.

### <Effects>

According to the first embodiment, the agents 200 are responsible for the monitoring task according to the performance of each of the agents 200 within the predetermined region 500 and the types of the main tasks. Therefore, it is not necessary to provide an agent (not illustrated) that performs only monitoring, and a fixed sensor (not illustrated), and thus it is possible to perform monitoring and transport by a small number of agents 200 as a whole. As a result, it is possible to improve the efficiency of the entire system and reduce the operation cost. In addition, since the agent control unit 300 calculates the routes of the agents 200 based on the monitoring evaluation indices, it is possible to make an efficient route plan while maintaining the reliability of each of the agents 200. As described above, in the first embodiment, it is possible to provide the agent control system W1 in which the agents 200 can perform a predetermined task while performing monitoring.

### Second Embodiment

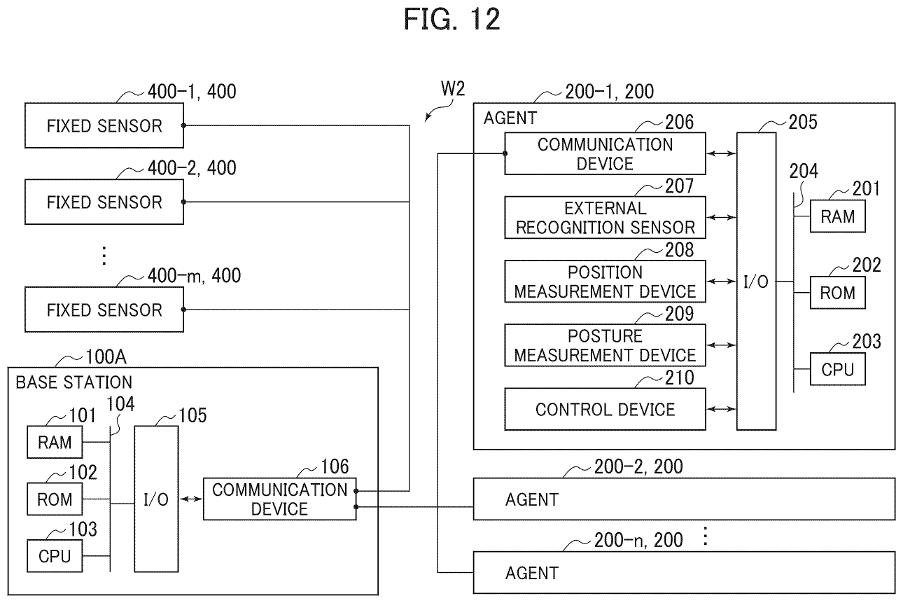

A second embodiment is different from the first embodiment in that an agent control unit 300A (see FIG. 12) includes a monitoring rate calculation unit 310 (see FIG. 12) and sets a predetermined monitoring rate in association with a monitoring index based on a result of detection by a fixed sensor 400 or the like (see FIG. 12). Other features are the same as or similar to those in the first embodiment. Therefore, features different from those in the first embodiment will be described and description regarding redundant features will be omitted.

FIG. 12 is a functional block diagram of an agent control system W2 according to the second embodiment.

As illustrated in FIG. 12, the agent control system W2 includes a base station 100A, agents 200-1 to 200-n, and fixed sensors 400-1 to 400-m. The fixed sensors 400-1 to 400-m are, for example, cameras and are disposed at intersections or the like within the predetermined region 500 (see FIG. 5A). Results of detection by the fixed sensors 400-1 to 400-m that change over time are transmitted to the base station 100A. The fixed sensors 400-1 to 400-m are collectively referred to as fixed sensors 400.

In the second embodiment, an example will be described in which the predetermined region 500 (see FIG. 5A) is monitored by the fixed sensors 400 disposed at locations, such as intersections, where the numbers of people and vehicles are large, and the agents 200 responsible for a monitoring task. Providing the plurality of fixed sensors 400 improves the sensing performance of the entire system, but increases the amount of communication in the entire system. Therefore, in the second embodiment, based on respective monitoring evaluation index at each location, monitoring rates of agents 200 and fixed sensors 400 at locations that are poorly monitored and at locations where pedestrian traffic volumes are high are set to be high and monitoring rates of agents 200 and fixed sensors 400 at locations with low pedestrian traffic volumes and low vehicle traffic volumes are set to be low. Therefore, it is possible to appropriately perform monitoring in the predetermined region 500 and reduce the amount of communication.

<Monitoring Rate Control in Case where Fixed Sensor is Present>

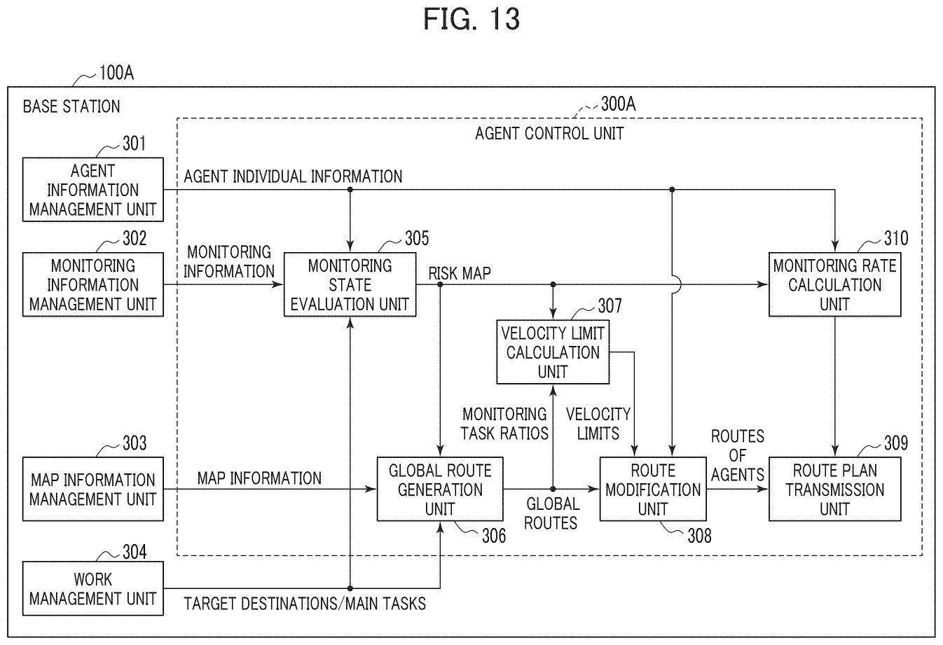

FIG. 13 is a functional block diagram illustrating a system configuration of the base station 100A.

As illustrated in FIG. 13, the agent control unit 300A includes a monitoring state evaluation unit 305, a global route generation unit 306, a velocity limit calculation unit 307, a route modification unit 308, a route plan transmission unit 309, and the monitoring rate calculation unit 310. Movement routes of the agents 200 (see FIG. 12) and monitoring rates of the agents 200 and the fixed sensor 400 are calculated and the results of the calculation are transmitted to the agents 200 and the fixed sensors 400.

### <Agent Information Management Unit 301>

An agent information management unit 301 illustrated in FIG. 13 holds individual information of the fixed sensors 400 (see FIG. 12) in addition to individual information of the agents 200 (see FIG. 12). The individual information of the fixed sensors 400 includes installation positions of the fixed sensors 400 and sensor information (sensing ranges, resolution, environmental resistance, and the like).

### <Monitoring Rate Calculation Unit 310>

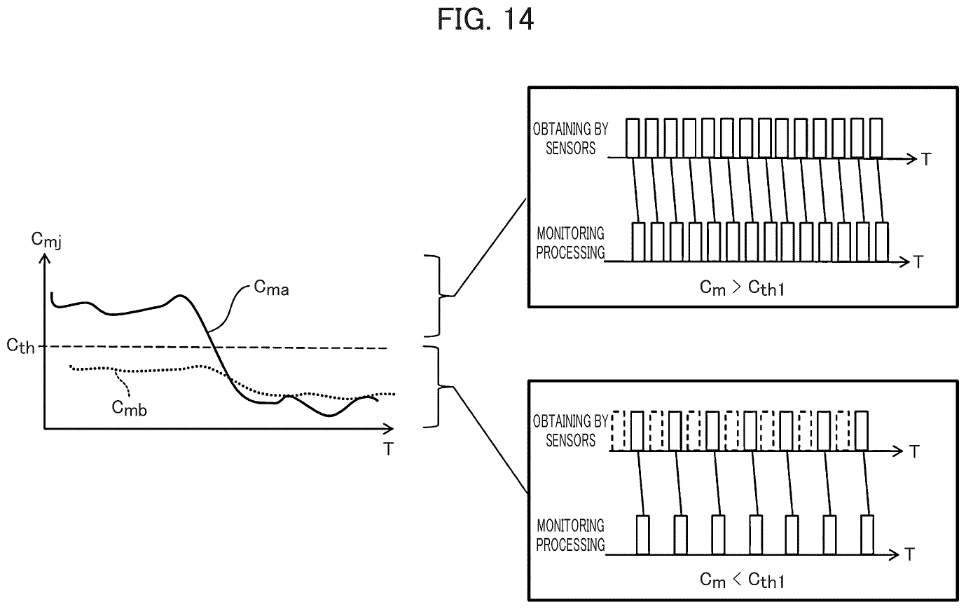

FIG. 14 is a diagram for explaining an example of an operation of the monitoring rate calculation unit (see also FIG. 13 as appropriate).

Note that “obtaining by sensors” in FIG. 14 indicates operation of the fixed sensors 400 (see FIG. 12) and the external recognition sensors 207 of the agents 200 (see FIG. 12) to generate monitoring information. In addition, “monitoring processing” in FIG. 14 indicates processing by the fixed sensors 400 and the agents 200 to transmit the monitoring information to the base station 100A (see FIG. 12). Furthermore, the horizontal axis of a graph on the left side of the sheet in FIG. 14 indicates time, and the vertical axis of the graph indicates a monitoring evaluation index Cₘⱼ. A solid-line graph in FIG. 14 indicates changes in a monitoring evaluation index Cₘⱼ at a predetermined location, and a broken-line graph in FIG. 14 indicates changes in a monitoring evaluation index Cₘⱼ at another location.

The monitoring rate calculation unit 310 calculates a communication rate (i.e., a monitoring rate) of the monitoring information of each of the agents 200 and the fixed sensors 400 based on the individual information of the agents 200 and the individual information of the fixed sensors 400 acquired from the agent information management unit 301, and the monitoring information acquired from the monitoring state evaluation unit 305. The monitoring rate calculated in the above-described manner is transmitted to the agents 200 and the fixed sensors 400 via the route plan transmission unit 309.

The monitoring rate is the number of times (i.e., the frequency) that each of the agents 200 or each of the fixed sensors 400 provides the monitoring information to the base station 100A (monitoring state evaluation unit 305 and the like), and is set for each location in the predetermined region 500.

The monitoring rate calculation unit 310 calculates the monitoring rates based on the monitoring evaluation indices Cₘⱼ. That is, the monitoring rate calculation unit 310 calculates the monitoring rates by comparing the monitoring evaluation indices Cₘⱼ with a predetermined threshold Cₜₕ. For example, in a case where a vehicle traffic volume and a pedestrian traffic volume in a certain section Eₘⱼ increase, and the monitoring evaluation index Cₘⱼ is equal to or higher than the threshold Cₜₕ, the monitoring rate calculation unit 310 increases monitoring rates of an agent 200 and a fixed sensor 400 in the area. That is, as the monitoring evaluation index Cₘⱼ is higher, the monitoring rate calculation unit 310 increases the monitoring rates at a location associated with this monitoring evaluation index Cₘⱼ.

On the other hand, in a case where the vehicle traffic volume decreases in a night-time period or the like and the monitoring evaluation index Cₘⱼ is less than the threshold Cₜₕ, the monitoring rate calculation unit 310 reduces the monitoring rates of the agent 200 and the fixed sensor 400. The method of calculating the monitoring rates is not limited thereto, and for example, the monitoring rates may be changed in inverse proportion to the values of the monitoring evaluation indices Cₘⱼ.

### <Effects>

According to the second embodiment, the monitoring rate calculation unit 310 changes the monitoring rates of the agents 200 and the fixed sensors 400 based on the monitoring information. Therefore, since amounts of communication are adjusted according to monitoring states in the predetermined region 500, it is possible to suppress an increase in the amount of communication in the entire system. By installing the fixed sensors 400 at locations, such as intersections, where pedestrian traffic volumes are high, the sensing capability of the entire system can be increased.

### Third Embodiment

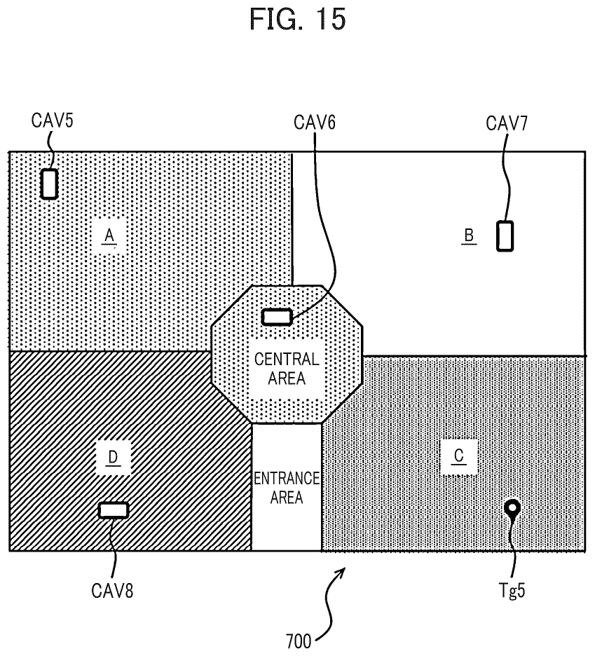

A third embodiment is different from the first embodiment in that the agent control system W1 (see FIG. 1) is used to transport a person and the like and perform monitoring in a theme park 700 (see FIG. 15). Other features (the configuration of the agent control system W1 and the like: see FIGS. 1, 2, and 4) are the same as or similar to those in the first embodiment. Therefore, features different from those in the first embodiment will be described and description regarding redundant features will be omitted.

### Example of Application to Moving Vehicles in Theme Park

FIG. 15 is an explanatory diagram of the theme park 700 to which the agent control system according to the third embodiment is applied.

In an example illustrated in FIG. 15, in the theme park 700, an entrance area and a central area are provided, and areas A to D surrounding the central area are provided. In addition, in the theme park 700, agents CAV5, CAV6, CAV7, and CAV8 are configured to transport passengers from a certain location to a predetermined target destination respectively. A case where the agent CAV5 illustrated in FIG. 15 picks up a passenger in the area A and transports the passenger to a target destination Tg5 in the area C will be described below.

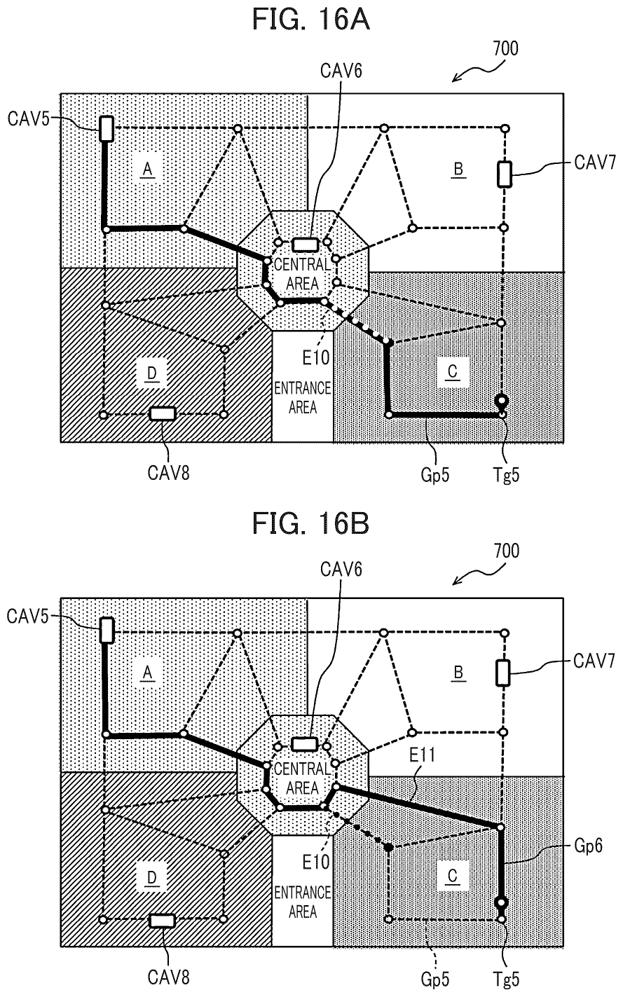

FIG. 16A is an explanatory diagram illustrating routes of the agents according to a comparative example.

As a map of the theme park 700, map information of a graph G(Eⱼ, Vⱼ) including nodes Vⱼ set in front of a main attraction and a section Et connecting the nodes Vⱼ is used. It is assumed that a section E10 that is a path extending from the central area toward the area C is crowded with pedestrians and that a monitoring evaluation index for the section E10 is relatively high (i.e., a high-risk state) at present. If the agent CAV5 carries a passenger and moves along the shortest route, a predetermined route Gp5 that extends through the section E10 as indicated in the comparative example in FIG. 16A is calculated.

FIG. 16B is an explanatory diagram illustrating global routes of the agents in the agent control system according to the third embodiment.

In the third embodiment, a route on which the agent CAV5 that transports a person or the like passes through a location with a low monitoring evaluation index is set. For example, a route Gp6 that extends through a section E11 with a lower risk than that in the section E10 described above is calculated. By the way, in a case where the agent CAV6 travels while being not in service in the central area, the route Gp5 on which the agent CAV6 moves around in the section E10 with a relatively large monitoring evaluation index is calculated.

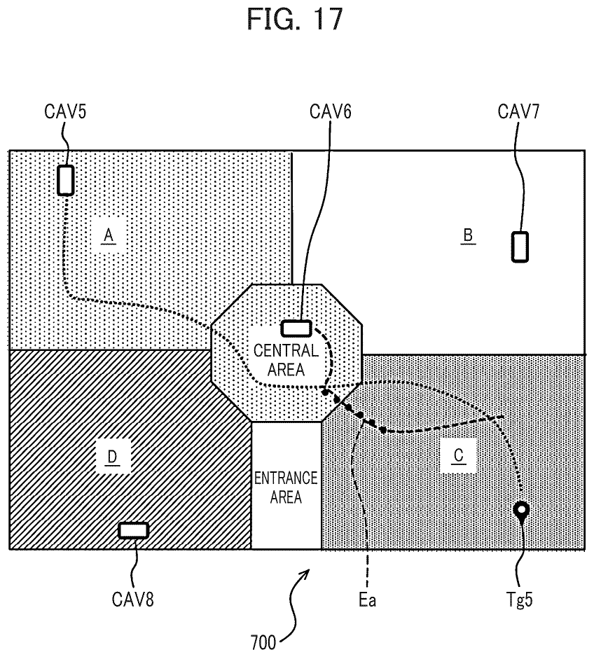

FIG. 17 is an explanatory diagram illustrating traveling routes of the agents in the agent control system according to the third embodiment.

Based on the calculation results described above, the agents CAV5 and CAV6 eventually travel along the routes (trajectories) as illustrated in FIG. 17. In this manner, the agent control system W1 (see FIG. 1) generates a route plan that imposes a monitoring task on each of the agents CAV5 and CAV6 according to the content of the main task. Therefore, during transport of a passenger, it is possible to secure safety by the agent CAV5 or the like moving along a low-risk route. The monitoring state of the theme park 700 can be improved by causing the agent CAV6 that travels while being not in service to monitor a high-risk area.

### Modification Examples

The agent control systems W1 and W2 and the like according to the present invention are described above in the embodiments, the present invention is not limited to these descriptions and can be variously modified.

For example, although each of the embodiments describes the case where the monitoring evaluation indices are calculated based on the agent individual information, the monitoring information, and the information of the target destinations and the main tasks of the agents 200, the embodiments are not limited thereto. That is, in the calculation of the monitoring evaluation indices, a part (e.g., the agent individual information and the information of the target destinations and the main tasks) of the information described above may be omitted. That is, the monitoring state evaluation unit 305 may calculate a monitoring evaluation index indicating whether a monitoring state at each location in the predetermined region is good, based on the monitoring information transmitted from the agents 200 that move in the predetermined region. In such a configuration, effects that are the same as or similar to those in each of the embodiments are obtained.

In addition, although the first embodiment describes the case where the agent control unit 300 (see FIG. 4) includes the velocity limit calculation unit 307 and the route modification unit 308, the first embodiment is not limited thereto. That is, one or both of the velocity limit calculation unit 307 and the route modification unit 308 may be omitted from the configuration of the agent control unit 300. The same applies to the second embodiment and the third embodiment.

In addition, although the first embodiment describes the case where the agent information management unit 301, the monitoring information management unit 302, the map information management unit 303, the work management unit 304, and the agent control unit 300 are disposed in the single base station 100 as illustrated in FIG. 4, the first embodiment is not limited thereto. That is, some of the configurations described above may be disposed in another server or a predetermined agent 200.

In addition, although the first embodiment describes the case where the monitoring evaluation indices Cₘⱼ are calculated based on the number of vehicles and pedestrians that have passed through the section Eⱼ within the predetermined time ΔT, the number of agents 200 responsible for the monitoring task, the road surface environment in the section Eⱼ, the traffic accident rate, and the like, the first embodiment is not limited thereto. That is, the monitoring state evaluation unit 305 may calculate the monitoring evaluation indices Cₘⱼ based on at least one of a traffic volume of pedestrians and general vehicles (vehicles that are different from the agents 200 and do not particularly perform monitoring), a traffic volume of monitoring vehicles including the agents 200, and a road condition.

In addition, although the first embodiment describes the case where the monitoring task ratios βᵢ are set based on the type of the main tasks (tasks) of the agents 200 and the performance of the external recognition sensors 207, the first embodiment is not limited thereto. That is, the global route generation unit 306 (route plan generation unit) may set the monitoring task ratios βᵢ in association with the agents 200 based on the types of the main tasks (tasks) included in the work management information.

In addition, although the second embodiment describes the case where the agent control system W2 (see FIG. 12) includes the plurality of fixed sensors 400, the second embodiment is not limited thereto. That is, in a configuration in which the fixed sensors 400 are omitted, the monitoring rate calculation unit 310 (see FIG. 13) may calculate the monitoring rates based on the monitoring evaluation indices and transmit the monitoring rates to the agents 200. In such a configuration, effects that are the same as or similar to those in the second embodiment are obtained.

In addition, the risk map that changes over time and indicates the monitoring evaluation indices for the locations described in the first embodiment may be displayed on a display (display device) of an administrator or the like. In addition, the monitoring rates that have been described above in the second embodiment and change over time may be associated with identification numbers of the fixed sensors 400 and the agents 200 and displayed on the display (display device) of the administrator or the like. Therefore, the administrator or the like easily grasps the monitoring evaluation indices and the monitoring rates in the predetermined region 500.

In addition, each of the embodiments describes the automated transport system in the predetermined region 500 (see FIG. 5A) and the moving object system in the theme park 700, the application of the present invention is not limited thereto. For example, the present invention can also be applied to the inside of a factory, a harbor, and a logistics warehouse where people and moving objects are present, and can also be applied to other regions for agriculture (farms) and sightseeing.

In addition, the embodiments can be combined as appropriate. For example, the second embodiment and the third embodiment may be combined and the system configuration (see FIGS. 12 and 13) according to the second embodiment may be applied to the theme park 700 (see FIG. 15) described in the third embodiment.

In addition, the processing in the agent control system W1 and the like may be executed as a predetermined program of a computer. The program described above can be provided via a communication line and can be written to a storage medium such as a CD-ROM and distributed.

In addition, each of the embodiments has been described in detail in order to clearly explain the present invention, and is not necessarily limited to including all of the configurations described. Furthermore, for a part of the configurations according to the embodiments, addition, removal, and replacement of another configuration can be made. Furthermore, the mechanisms and configurations described above are considered necessary for the explanation, and do not necessarily represent all mechanisms and configurations in a product.

### LIST OF REFERENCE SIGNS

100, 100A: base station
200, 200-1, 200-2, . . . , 200n: agent
207: external recognition sensor
300, 300A: agent control unit
301: agent information management unit
302: monitoring information management unit
303: map information management unit
304: work management unit
305: monitoring state evaluation unit
306: global route generation unit (route plan generation unit)
307: velocity limit calculation unit
308: route modification unit
309: route plan transmission unit
310: monitoring rate calculation unit
400, 400-1, 400-2, 400-m: fixed sensor
500: predetermined region
700: theme park (predetermined region)
CAV1, CAV2, CAV3, CAV4, CAV5, CAV6, CAV7, CAV8: agent
W1, W2: agent control system

1. An agent control system comprising:
a monitoring state evaluation unit that calculates, based on monitoring information transmitted from an agent that moves in a predetermined region, a monitoring evaluation index indicating whether or not a monitoring state at each location in the predetermined region is good;
a route plan generation unit that generates a route plan for the agent based on work management information including a destination of the agent and a type of a task and the monitoring evaluation index; and
a route plan transmission unit that transmits data of the route plan to the agent.

2. The agent control system according to claim 1,
wherein the route plan generation unit sets, based on the type of the task included in the work management information, a monitoring task ratio indicating a ratio of a degree of importance of monitoring with respect to the task in association with the agent, and
the route plan generation unit generates the route plan to cause the agent to travel on a route with the monitoring evaluation index that is relatively higher as the monitoring task ratio is higher.

3. The agent control system according to claim 2,
wherein the route plan generation unit sets the monitoring task ratio such that the monitoring task ratio in a case where the task is traveling not in service, dispatch, or movement for supply of electric power is set to a value higher than a value of the monitoring task ratio in a case where the task is transport of a person or a package.

4. The agent control system according to claim 2,
wherein the route plan generation unit sets the monitoring task ratio to a value that is higher as performance of an external recognition sensor included in the agent is higher.

5. The agent control system according to claim 2, further comprising:
a velocity limit calculation unit that calculates a velocity limit for the agent based on the monitoring evaluation index and the monitoring task ratio,
wherein the velocity limit calculation unit sets the velocity limit for the agent caused to travel in a region for which the monitoring evaluation index is relatively high such that the velocity limit in a case where the monitoring task ratio is less than a predetermined value is lower than the velocity limit in a case where the monitoring task ratio is equal to or greater than the predetermined value.

6. The agent control system according to claim 5, further comprising:
a route modification unit that modifies a route of the agent,
wherein the route modification unit modifies a traveling route of the agent based on the velocity limit and the monitoring information to suppress a velocity at which the agent travels to the velocity limit or lower and avoid contact with an object around the agent.

7. The agent control system according to claim 1,
wherein the monitoring state evaluation unit calculates the monitoring evaluation index based on at least one of a traffic volume of pedestrians and general vehicles, a traffic volume of monitoring vehicles including the agent, and a road situation.

8. The agent control system according to claim 1, further comprising:
a monitoring rate calculation unit that sets, based on the monitoring evaluation index, for each location in the predetermined region, a monitoring rate that is a number of times that the agent provides monitoring information to the monitoring state evaluation unit per unit of time,
wherein as the monitoring evaluation index is higher, the monitoring rate calculation unit increases the monitoring rate at a location associated with the monitoring evaluation index.

9. An agent control method comprising:
monitoring state evaluation processing of calculating, based on monitoring information transmitted from an agent that moves in a predetermined region, a monitoring evaluation index indicating whether or not a monitoring state at each location in the predetermined region is good;
route plan generation processing of generating a route plan for the agent based on work management information including a destination of the agent and a type of a task and the monitoring evaluation index; and
route plan transmission processing of transmitting data of the route plan to the agent.
